(19) United States
(12) Patent Application Publication
(10) Pub. No.: US 2012/0159108 A1
(43) Pub. Date: Jun. 21, 2012

(54) CONTROL DEVICE FOR A VENDING MACHINE

(75) Inventors: Takayuki Akuzawa, Isesaki-shi (JP); Hiroshi Kudose, Isesaki-shi (JP); Hideyuki Matsumoto, Isesaki-shi (JP)

(73) Assignee: SANDEN CORPORATION, Isesaki-shi (JP)

(21) Appl. No.: 13/394,077

(22) PCT Filed: Sep. 3, 2010
(86) PCT No.: PCT/JP2010/005444

§ 371 Date: Mar. 2, 2012

(30) Foreign Application Priority Data
Sep. 3, 2009 (JP) 2009-203564

(51) Int. Cl. G06F 12/02

(52) U.S. Cl. 711/165; 711/E12.002

(57) ABSTRACT

[PROBLEM TO BE SOLVED]

To provide a control device of vending machine that can reduce rewriting time of a control program and can perform control process during the rewriting of the control program.

[SOLUTION]

The device of vending machine comprises an electrically rewritable nonvolatile flash memory (340) for storing an initial processing program (341) and a control program (342), and a volatile SDRAM (330). The initial processing program (341) transfers the control program (342) from the flash memory (340) to the SDRAM (330), and a control process of the vending machine is performed via execution of the control program (342) in the SDRAM (330). The writing process to the flash memory (340) is executed in parallel with the control process.

This application is a U.S. National Phase under 35 U.S.C. §371 of International Application No. PCT/JP2010/005444, filed Sep. 3, 2010.

### TECHNICAL FIELD

The present invention relates to a control device that connects to a control terminal, various sensors, an operation unit, and the like for controlling components of a vending machine to integrally control the vending machine.

### BACKGROUND ART

This type of control device of vending machine includes a microcomputer, a ROM storing a control program, a RAM used as a work area in operation, an interface circuit for connection to various devices and a vending machine LAN, and the like. The microcomputer executes the control program on the ROM to operate the control device. In this type of control device of vending machine, an electrically rewritable nonvolatile memory, such as a flash memory, is used as a storage medium of the control program to handle an upgrade after the shipment. A rewriting process of the control program is executed by moving the process of the microcomputer from the control program on the ROM to a rewriting process program expanded to the RAM. In the rewriting process program, a new control program acquired from a memory card or a communication line is written into the ROM. Once the writing process is completed, the control device is rebooted to start a control process based on the new control program (for example, see Patent Literature 1).
PATENT LITERATURE 1: Japanese Patent Publication 2001-34822

### SUMMARY OF INVENTION

### Problems to be Solved by the Invention

However, in the conventional control device, there is a problem that other control processes usually executed in the control program cannot be executed while the rewriting process of the control program is executed. The rewriting process time largely depends on the writing time to an electrically rewritable ROM, such as a flash memory, and the time is usually several tens of seconds. Since the control program cannot be executed during the rewriting process, there is a problem that the temperature management and the like in the vending machine cannot be performed, as well as a problem that an abnormality and the like cannot be detected. If the working hours are long, the operation time of the vending machine is reduced. Therefore, there are problems that the sales opportunities are lost and that the work efficiency of the worker is reduced.

Meanwhile, in a production line of the control device, there is a demand for writing, on the line, the control program in a ROM in which the control program is not written, instead of installing a ROM in which the control program is written in advance. This is derived from a demand for reducing the cost by standardizing the control device before the installation, regardless of the model of the vending machine. There is also a demand for reducing, as much as possible, the waiting time of the worker that would be generated during writing of the control program, from the perspective of improving the efficiency of the production line.

The present invention has been made in view of the circumstances, and a first object of the present invention is to provide a control device that can reduce rewriting time of a control program and that can perform a control operation even during a rewriting process.

A second object of the present invention is to provide a control device that can reduce operations during writing of a control program in a production line.

### Means for Solving the Problems

To attain the objects, the present invention provides a control device of vending machine for controlling various devices of the vending machine by executing a control program with a microcomputer, comprising an electrically rewritable nonvolatile first memory for storing an initial processing program and a control program, and a volatile second memory, and wherein in the initial processing program, the control program is transferred from the first memory to the second memory, and then the process is moved to the control program transferred to the second memory.

According to the present invention, the microcomputer executes the control program stored in the second memory, not the first memory. Therefore, the microcomputer can rewrite or newly write the control program stored in the first memory in parallel with the process of the control program. As a result, the control process of the vending machine can be executed even during the writing process of the control program to the first memory. This can substantially reduce the rewriting time of the control program for the worker.

In a suitable aspect of the present invention, to rewrite the control program, the control program collectively acquires a new control program from an external storage medium or through a communication line to store the new control program in the second memory and sequentially overwrites the control program stored in the first memory with the new control program stored in the second memory in parallel with a control process of the vending machine.

In a suitable aspect of the present invention, if the control program is not stored in the first memory, the initial processing program collectively acquires the control program from the external storage medium or through the communication line to store the control program in the second memory and then moves the process to the control program transferred to the second memory, and the control program writes, in the first memory, the control program stored in the second memory in parallel with the control process of the vending machine.

In this way, the process of writing the control program from the second memory to the first memory is executed in the present invention, and the writing process is executed in the control program of the second memory. Therefore, as described, the control process of the vending machine can be executed even during the writing process of the control program to the first memory, and this can substantially reduce rewriting time of the control program for the worker.

### ADVANTAGES OF THE INVENTION

As described, according to the present invention, the microcomputer executes the control program stored in the second memory, not the first memory. Therefore, the microcomputer can rewrite or newly write the control program stored in the first memory in parallel with the process of the control program. As a result, the control process of the vending machine can be executed even during the writing process of the control program to the first memory. This can substantially reduce the rewriting time of the control program for the worker.

### BRIEF DESCRIPTION OF THE DRAWINGS

FIG. 1 is an exploded perspective view of a control device of vending machine.

FIG. 2 is a diagram for explaining a connection mode of a main circuit board and a sub circuit board.

FIG. 3 is a functional block diagram of the main circuit board.

FIG. 4 is a flow chart of an initial processing program for explaining an operation of the control device.

FIG. 5 is a flow chart of a main control program for explaining an operation of the control device.

### DESCRIPTION OF EMBODIMENTS

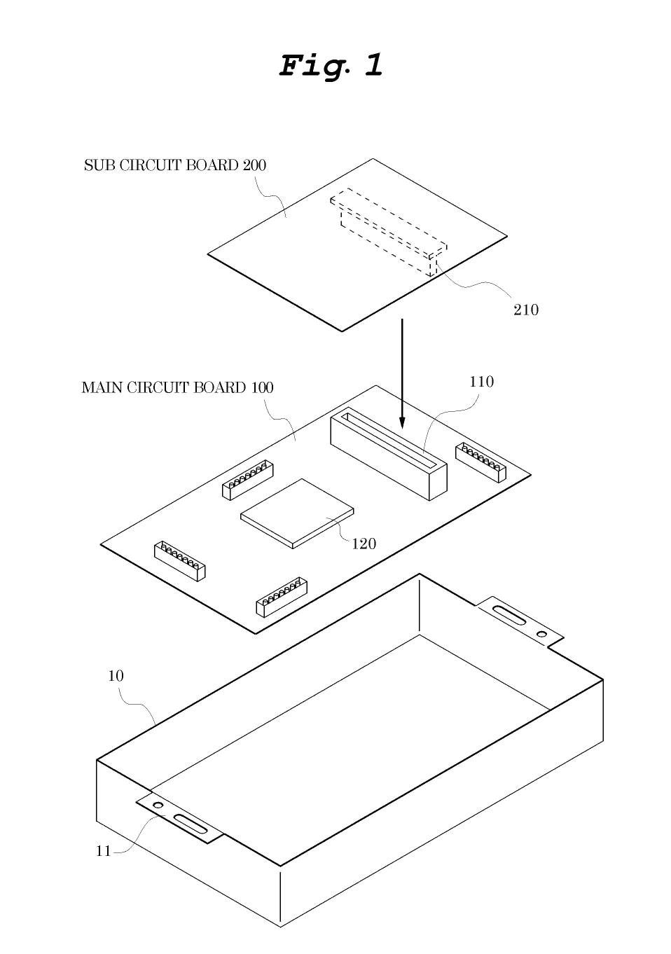

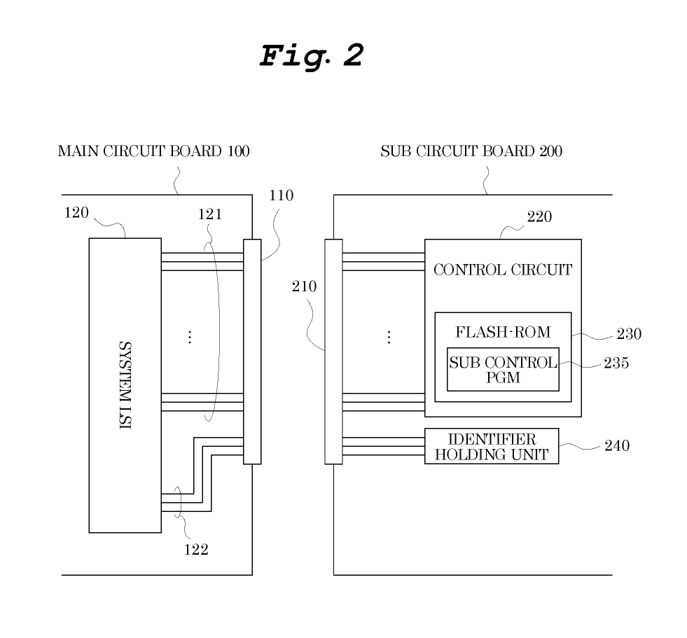

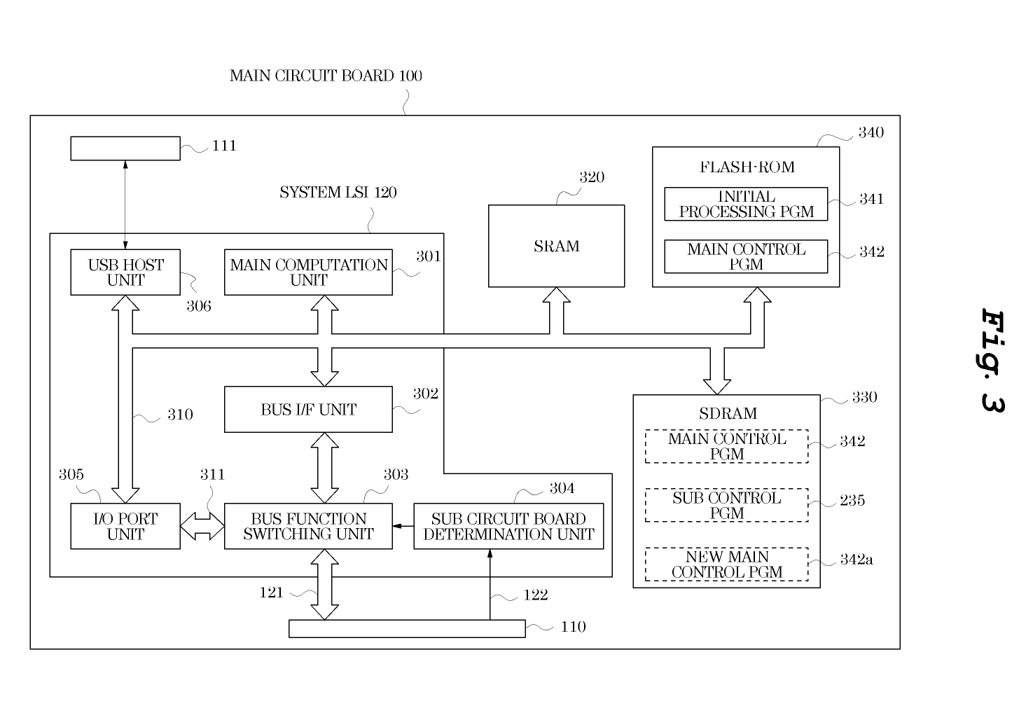

A control device of vending machine according to an embodiment of the present invention will be described with reference to the drawings. FIG. 1 is an exploded perspective view of the control device of vending machine. FIG. 2 is a diagram for explaining a connection mode of a main circuit board and a sub circuit board. FIG. 3 is a functional block diagram of the main circuit board.

As shown in FIG. 1, the control device of vending machine according to the present embodiment includes a box-shaped case 10 with an open lower surface (upper surface in FIG. 1) and a main circuit board 100 as well as a sub circuit board 200 accommodated in the case 10. Attachment pieces 11 for attachment to the vending machine protrude at edges of the opening of the case 10. The main circuit board 100 and the sub circuit board 200 are arranged on top of each other in a thickness direction. A female first connector 110 is provided on a surface of the main circuit board 100 opposing the sub circuit board 200. Meanwhile, a male second connector 210 is provided on a surface of the sub circuit board 200 opposing the main circuit board 100. The second connector 210 is fitted to a fitting section of the first connector 110 to electrically connect the main circuit board 100 and the sub circuit board 200 without involving a connection cable or the like, and the main circuit board 100 and the sub circuit board 200 are mechanically held and combined. The main circuit board 100 and the sub circuit board are arranged in parallel to each other when the boards are connected. It is suitable if the main circuit board 100 has common, general-purpose functions of main vending machines, and the sub circuit board 200 has functions specific to a certain vending machine. Therefore, it should be noted that the sub circuit board 200 can be mounted according to the type, the functions, and the like of the vending machine, and the sub circuit board 200 is not necessarily essential.

As shown in FIG. 2, a system LSI 120 is mounted on the main circuit board 100. The system LSI 120 is a type of a microcomputer with integrated functions of a CPU, a memory, a timer, an I/O, and the like, and a gate array IC is used in the present embodiment. A bus line 121 as part of bus lines of the system LSI 120 is connected to the first connector 110. An I/O port 122 as part of I/O ports of the system LSI 120 is also connected to the first connector 110. Details of the main circuit board 100 will be described later.

A control circuit 220 is mounted on the sub circuit board 200, and the control circuit 220 is connected to the bus line 121 of the system LSI 120 through the second connector 210 and the first connector 110. The control circuit 220 is implemented in accordance with the functions of the sub circuit board 200, and various circuit configurations are possible. Specifically, a bus line that connects the second connector 210 and the control circuit 220 may be implemented as a system bus or may be implemented as an input/output bus. In the former case, it is suitable if a sub control program 235 for the sub circuit board 200 is stored as necessary in a flash memory 230 as nonvolatile storage means connected to the system bus. As described later, the system LSI 120 of the main circuit board 100 executes the sub control program 235. The sub circuit board 200 includes an identifier holding unit 240 that holds an identifier for identifying the type of the sub circuit board 200. The identifier holding unit 240 is connected to the I/O port 122 of the system LSI 120 through the second connector 210 and the first connector 110. In the identifier holding unit 240, for example, a nonvolatile memory that holds an identifier or a DIP switch that can set an identifier may be used to allow changing the value of the identifier, or the identifier holding unit 240 may be implemented as hardware to indicate a fixed value.

The details of the main circuit board 100 will be described with reference to the functional block diagram of FIG. 3. Only details related to the concept of the present invention will be described here. As shown in FIG. 3, the system LSI 120 includes a main computation unit 301, a bus interface unit 302, a bus function switching unit 303, a sub circuit board determination unit 304, an input/output port unit 305, and a USB (Universal Serial Bus) host unit 306. A system bus 310 in the system LSI 120 connects the main computation unit 301, the bus interface unit 302, the input/output port unit 305, and the USB host unit 306. The USB host unit 306, which is connected to a USB connector 111, functions as a USB host for an external device (USB client), such as a computer connected to the connector 111.

An SRAM 320 and an SDRAM 330 as volatile storage means and a flash memory 340 as nonvolatile storage means are mounted on the main circuit board 100. The memories 320 to 340 are connected to the system bus 310 of the system LSI 120. The memories are arranged in an address space, and particularly, the flash memory 340 is arranged at a position starting from a predetermined start address.

An initial processing program 341 executed in an initial operation of the control device and a main control program 342 are stored in the flash memory 340. A program according to the model and the like of the vending machine is written as the main control program 342 when the control device is installed on the vending machine. Meanwhile, the initial processing program is common to all vending machines and is written in advance in the control device before the installation. The initial processing program is arranged at a position starting from a predetermined start address, and the system LSI 120 executes the initial processing program when the control device is turned on or rebooted.

The SRAM 320 holds various data during operations of the control device and is backed up by a battery not shown. As described later, the SDRAM 330 stores the main control program 342 transferred by the initial processing program 341 from an external device through the flash memory 340 or the USB host unit 306 and stores the sub control program 235 transferred from the sub circuit board 200. As described later, the SDRAM 330 temporarily stores a new main control program 342a when the main control program 342 stored in the flash memory 340 is rewritten.

The bus interface unit 302 arbitrates the control circuit 220 on the sub circuit board 200 as an external circuit, the functional units in the system LSI 120, and the memories 320 to 340, when the sub circuit board 200 is mounted and the sub circuit board 200 is connected through the system bus. More specifically, the access speed to the control circuit 220 on the sub circuit board 200 as an external circuit is often slower than the access speed to the functional units in the system LSI 120 and the memories 320 to 340. Therefore, the bus interface unit 302 controls the wait for the external circuit to slow down the access speed in the system bus 310.

The sub circuit board determination unit 304 detects the attachment of the sub circuit board 200 to the first connector 110 and detects the identifier from the identifier holding unit 240 of the sub circuit board 200 to determine the type of the sub circuit board 200. The sub circuit board determination unit 304 at least determines whether the mode of the connection with the sub circuit board 200 is the system bus or the input/output bus.

If the connection mode determined by the sub circuit board determination unit 304 is the system bus, the bus function switching unit 303 executes a switching process to connect the bus line 121 of the system LSI 120 to the system bus 310. On the other hand, if the connection mode determined by the sub circuit board determination unit 304 is the input/output bus, the bus function switching unit 303 executes a switching process to connect the input/output bus 311, which is connected with the input/output port unit 305, to the bus line 121 of the system LSI 120.

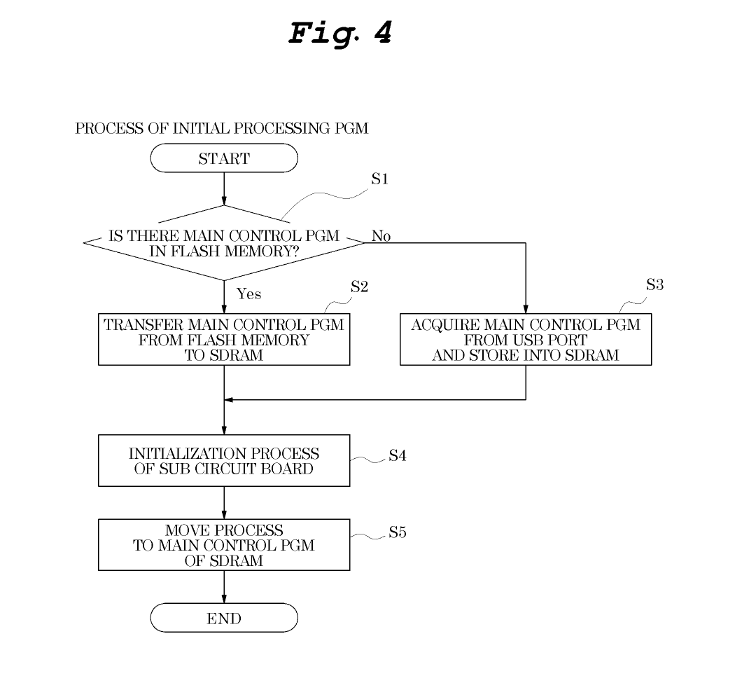

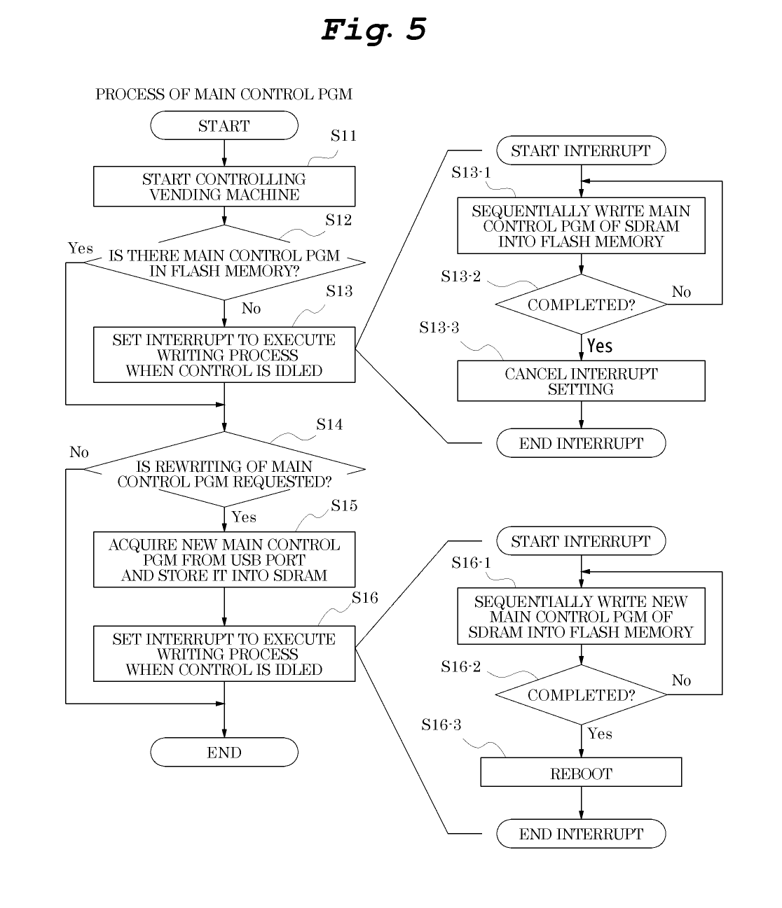

Operations of the control device of vending machine according to the present embodiment will be described with reference to flow charts of FIGS. 4 and 5. FIG. 4 is a flow chart of the initial processing program for explaining an operation of the control device. FIG. 5 is a flow chart of the main control program for explaining an operation of the control device.

When the control device is turned on or rebooted (reset operation), the main computation unit 301 executes the initial processing program 341 stored at the predetermined start address of the flash memory 340 to start the control device. In the process of the initial processing program 341, the main control program 342 is transferred from the flash memory 340 to the SDRAM 330 if the main control program 342 is stored in the flash memory 340 (steps S1 and S2). Meanwhile, if the main control program 342 is not stored in the flash memory 340, the main control program 342 is acquired from an external device through the USB host unit 306, and the main control program 342 is transferred to the SDRAM 330 (steps S1 and S3). The initial processing program 341 executes initial processing of the sub circuit board 200 (step S4). Specifically, the type of the mounted sub circuit board 200 is identified to control the bus function switching unit 303 according to the type. If the sub control program 235 is stored on the sub circuit board 200, the sub control program 235 is transferred to the SDRAM 330. After the process, the main computation unit 301 moves the process to the main control program 342 stored in the SDRAM 330 (step S5).

A normal control process of the vending machine is started in the main control program 342 (step S11). The control process is the same as the conventional control process, and the process will not be described here. Meanwhile, in the main control program 342, if the main control program 342 is not stored in the flash memory 340 (step S12), a process of writing the main control program 342 into the flash memory 340 is executed (step S13). It should be noted that the writing process is executed in parallel with the control process of the vending machine. Specifically, an interrupt is set to execute a writing process routine when the control process is idled (step S13). In the interruption process, a process of sequentially writing the main control program 342 into the flash memory 340 is started (step S13-1), and the interruption setting is cancelled when the writing process is completed (steps S13-2 and S13-3).

In the main control program 342, if update of the main control program is requested from a predetermined operation button, from a remote control, or from an external device connected to the USB host unit 306 (which are not shown) (step S14), the new main control program 342a is acquired from the external device connected to the USB host unit 306 and stored into the SDRAM 330 (step S15). Next, a process of writing the acquired new main control program 342a into the flash memory 340 is executed (step S16). It should be noted that the writing process is executed in parallel with the control process of the vending machine. Specifically, an interrupt is set to execute a writing process routine when the control process is idled (step S16). In the interruption process, a process of sequentially writing the main control program 342a into the flash memory 340 is started (step S16-1), and the control device is rebooted when the writing process is finished (steps S16-2 and S16-3). The reboot cancels the interruption setting. After the reboot, the initial processing program 341 is executed, and a process by the new main control program 342a is started.

As described in detail, according to the control device of vending machine of the present embodiment, the main computation unit 301 executes the control process of the vending machine by executing the main control program transferred from the flash memory 340 to the SDRAM 330, not the main control program 342 stored in the flash memory 340. As a result, the writing process to the flash memory 340, such as new writing and subsequent rewriting of the main control program 342, and the control process of the vending machine can be executed in parallel. Therefore, a conventionally required uncontrollable period during the writing time of the flash memory 340 can be eliminated. This can substantially reduce the writing time of the control program for the worker. This is suitable because the work efficiency significantly improves, and particularly, the writing process and the performance test of the vending machine can be performed in parallel in the installation line.

Although an embodiment of the present invention has been described in detail, the present invention is not limited to this. For example, the main control program 342 is first written in the SDRAM 330, and then the interruption setting is just canceled in the embodiment (step S13-3). However, the rebooting may also be performed as in the rewriting process.

Although the USB host unit 306 is used as the means for acquiring the main control program 342 from an external device in the embodiment, other means may be used. For example, an interface that allows mounting an attachable and detachable portable storage medium may be provided to the control device to acquire the main control program 342 from the portable storage medium. Furthermore, for example, a memory storing the main control program 342 may be installed on the sub circuit board 200, or an interface circuit may be provided to the sub circuit board 200 to acquire the main control program 342 from an external device through the sub circuit board 200.

Although the main circuit board 100 and the sub circuit board 200 are arranged on top of each other in the embodiment, a parallel connection mode is also possible. Although the main circuit board 100 and the sub circuit board 200 are directly connected through the connectors in the embodiment, a connection through a cable is also possible. Although the gate array IC is used as the microcomputer in the embodiment, other types of ICs may be used.

### INDUSTRIAL APPLICABILITY

The present invention is suitable for a control device that connects to a control terminal, various sensors, an operation unit, and the like for controlling components of a vending machine to comprehensively control the vending machine.

### DESCRIPTION OF SYMBOLS

100 . . . main circuit board, 120 . . . system LSI, 301 . . . main computation unit, 306 . . . USB host unit, 320 . . . SRAM, 330 . . . SDRAM, 340 . . . flash memory, 341 . . . initial processing program, 342 . . . main control program, 200 . . . sub circuit board

1. A control device of vending machine for controlling various devices of the vending machine by executing a control program with a microcomputer, comprising:
an electrically rewritable nonvolatile first memory for storing an initial processing program and a control program, and
a volatile second memory, and wherein:
in the initial processing program, the control program is transferred from the first memory to the second memory, and then the process is moved to the control program transferred to the second memory.

2. The control device of vending machine according to claim 1, wherein
for rewriting the control program, the control program collectively acquires a new control program from an external storage medium or through a communication line to store the new control program into the second memory, and sequentially overwrites the control program stored in the first memory with the new control program stored in the second memory in parallel with a control process of the vending machine.

3. The control device of vending machine according to claim 1, wherein
if the control program is not stored in the first memory, the initial processing program collectively acquires the control program from an external storage medium or through a communication line to store the control program into the second memory and then moves the process to the control program transferred to the second memory, and
the control program writes, into the first memory, the control program stored in the second memory in parallel with a control process of the vending machine.

4. The control device of vending machine according to claim 2 or 3, wherein
the control program reboots the control device after completing the writing process of the control program to the first memory.

5. The control device of vending machine according to claim 2 or 3, wherein
the control program executes the writing process of the control program to the first memory when the control process of the vending machine is idled.
